(19) United States
(12) Patent Application Publication
(10) Pub. No.: US 2008/0183772 A1
(43) Pub. Date: Jul. 31, 2008

(54) Backup relative to install media

(76) Inventor: Bradd W. Szonye, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/700,742

(22) Filed: Jan. 30, 2007

(51) Int. Cl. G06F 17/00

(52) U.S. Cl. 707/204

(57) ABSTRACT

In an embodiment of the invention, an apparatus and method for backup relative to install media perform the steps of: if a file on the file system is not part of an installed software package, then adding the file to a backup list; if the file is part of an installed software package, then adding the file to the backup list if the file has changed from a packaged version of the file or if the file is dynamically generated by an installed software package; and if the file has not changed from a packaged version of the file or is not dynamically generated by an installed software package, then adding the file to an exclude list.

### TECHNICAL FIELD

Embodiments of the invention relate generally to backup relative to install media.

### BACKGROUND

Data archiving systems (i.e., backup systems) typically create backups of all of a computer system's data. However, such backups can contain many gigabytes of data that could be recovered simply by re-installing the data by use of an associated installation media or/and by patching the computer system via patches download. Because of these large data sizes, data archiving systems permit users to select which files to include or exclude from backup copies. Such systems are error-prone, because any user data accidentally placed in those excluded locations become non-recoverable (because the data is not backed up) in the event of a disaster that affects the computer system. For example, if a user forgets to include a critical file for backup, or if the user mistakenly places a critical file in an excluded location, then that file becomes non-recoverable.

Some software installation/packaging systems also track the installed files and whether the files have changed from the version of the same files in the original installation media. However, these prior systems are not designed for use by archiving systems, and integrating the two systems is difficult.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a flow diagram of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

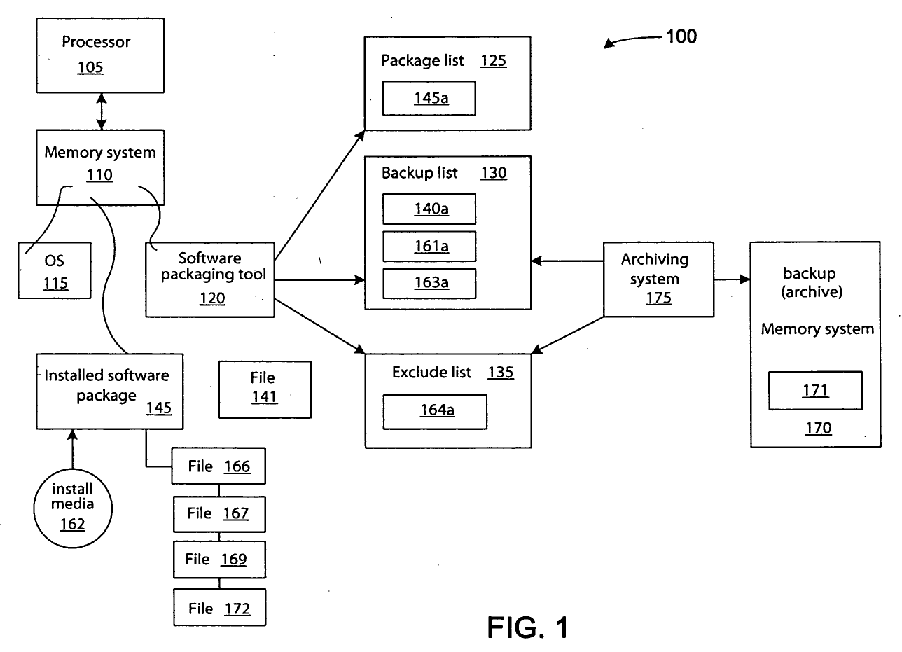

FIG. 1 is a block diagram of an apparatus (system) 100 in accordance with an embodiment of the invention. Typically, the apparatus 100 is a computer system or other types of computing devices. The apparatus 100 includes a processor 105 and a memory system 110. The memory system 110 may be formed by multiple standard memory devices as known to those skilled in the art. The processor 105 executes the various software/firmware in the memory system 110. For example, the processor 105 executes an operating system (OS) 115 and a software packaging tool 120 that are stored in the memory system 110. The OS 115 performs various standard computer management operations and other standard OS operations in the system 100. The software packaging tool 120 performs management operations of computer software packages in the system 100 such as, for example, installing, uninstalling, verifying, querying, and updating of files in the computer software packages, and maintaining information about the files in the software package such as file versions, file descriptions, and the like. One example of a software package management product is the RPM package manager which is a LINUX software package.

An embodiment of the invention uses the software packaging tool 120 to create a list 125 of installed software packages (the package list 125), a list 130 of files that are identical to the packaged version of the files (the exclude list 130), and a list 135 of files which differ from the packaged version of the files (the backup list 135).

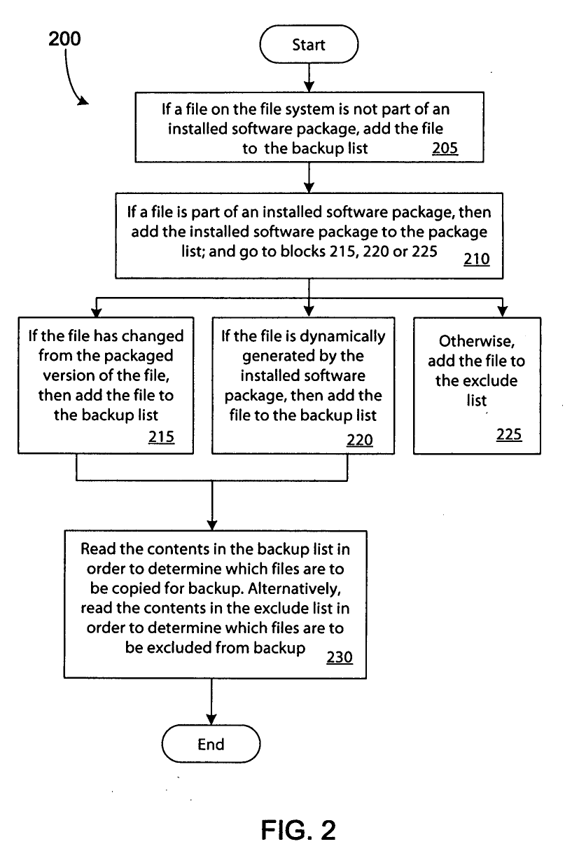

Reference is now made to the system 100 in FIG. 1 and the method 200 in FIG. 2 to describe additional details of an embodiment of the invention. In the method 200, the software packaging tool 120 (FIG. 1) will check each file in the file system of a computer system 100, and the software packaging tool 120 will then perform the below steps in the method 200. The software packaging tool 120 checks the file attributes of file in order to determine the various file characteristics that are mentioned below in blocks 205 through 225.

In block 205, if a file on the file system is not part of an installed software package, then the file is added to the backup list 130. An installed software package will typically contain a list of files. For example, if a file 140 is not part of the installed software package 145 and is also not part of any other installed software package (e.g., OS 115) in the file system 150, then the file 140 is added to the backup list 130. The tool 120 determines if the file 140 is part or not part of a software package 145 or other installed software package in the computer system 100 by checking the attributes (metadata) 141 of the file 140. Methods of checking file attributes or metadata are well known to those skilled in the art. Typically, the name 140a of the file 140 is instead added to the backup list 130. As an example, the file 140 is a user-created file that contains the user's notes on how to use a software program. The file 140 can be other examples of files that are created independently of an installed software package in the file system 150.

In block 210, if a file is, instead, part of an installed software package, then the installed software package is added to the package list 125. For example, if the file 160 is part of the installed software package 145, then the installed software package 145 is added to the package list 125. Typically, the name 145a of the installed software package 145 is instead added to the package list 125. The installed software package list 145 is installed in the file system 150 from an installation media 162 (e.g., installation CD or patches).

The method 200 then checks the file 160 that is part of an installed software package, in accordance with the steps in blocks 215, 220, and 225. The software packaging tool 120 tracks and determines if the file 160 is part of package 145 by examining the file attributes 166 of the file 160.

In block 215, if the file 160 has changed from the packaged version of the file 160 to a modified version, then the file 160 is added to the backup list 130. For example, the file 160 can be a software configuration file 161 that was originally installed as part of the installed software package 145 that was installed to the file system 150 from an install media 162, but the configuration file 161 has been modified from the originally installed version of the file 161. That modified configuration file 161 is added to the backup list 130. Typically, the name 161a of the file 161 is instead added to the backup list 130. As an example, the file 161 is a file that has been modified by a user or system administrator to customize the file 161 for use in the file system 150 or computer system 100. The software packaging tool 120 tracks and determines the changes of the file 161 by examining the file attributes 167 of the file 161.

In block 220, if the file 160 is dynamically generated by installed software package 145 (e.g., if the file 160 is generated when the installed software package 145 is executing), then the file 160 is added to the backup list 130. For example, the file 160 can be a file 163 that contains statistics or other data that is produced when the installed software package 145 is executing or executed. Therefore, the file 163 has data that is created by the actual use of the installed software package 145 and can not be re-created if the original file 163 becomes unrecoverable or corrupted. Typically, the name 163a of the file 163 is instead added to the backup list 130. The software packaging tool 120 identifies the file 163 as a dynamically created file, by examining the file attributes 169 of the file 163.

In block 225, if the file 160 is not a file that falls under the category in blocks 215 and 220, then the file 160 is added to the exclude list 135. For example, the file 160 can be a software program file 164 that is part of the installed software package 145. When the file system 150 is running or when the installed software package 145 is executing, this file 164 will not be changed from the packaged version of the file 164 that was originally installed in the file system as part of the software package 145 and is also not a dynamically generated file when the software package 145 is executing. Typically, the name 164a of the file 164 is instead added to the exclude list 135. The software packaging tool 120 identifies the file 164 as part of the installed software package 145, by examining the file attributes 172 of the file 164. This file 164 will not require to be archived (backed up) because this file 164 is also contained in the install media 162. Therefore, if the file 164 in the file system 150 becomes un-recoverable or corrupted, the file 164 can be recovered from the install media 162. Since the file 164 is not required to be stored in a back-up (archive) memory system 170 (FIG. 1), memory space is saved in the memory system 170 and the time for backup of the data in the file system 150 is advantageously reduced.

In block 230, a standard archiving system 175 (FIG. 1) can read the contents in the backup list 130 to determine which files are to be copied by the archiving system 175 to the back-up memory system 170. As discussed above, the files in the backup list 130 contain data that differ from data in the same files in the installation media 162. For example, when the archiving system 145 reads the file names 140a, 161a, and 163a from the backup list 130, the archiving system 145 will copy the respective corresponding files 140, 161, and 163 to the back-up memory system 170. Other standard archiving systems 175 will alternatively read the contents in the exclude list 135 to determine which files are to be excluded from backup, and will instead archive (back up) files that are not in the exclude list 135. For example, when the archiving system 145 reads the file name 164a from the exclude list 135, the archiving system 145 will backup all other files (e.g., files 140, 161, and 163) to the back-up memory system 170 except the file 164. Thus, the backup step can exclude large amounts of redundant data, which leads to reduced backup time and less backup memory requirements. Examples of standard archiving systems include the tar program and CPIP program which are both Unix-based software, the Symantec Norton Ghost application, and Microsoft DPS.

The backup list 130 and exclude list 130 will typically be in a data format (e.g., text files, spreadsheet, etc.) that is readable by the archiving system 175.

To restore a system 100 that is archived as above, all of the software packages on the package list 125 are first installed (typically by use of the packages' installation media 162), and the archived data 171 in the backup memory system 170 is then restored in the system 100.

An embodiment of the invention advantageously avoids the problem of previous methods by using existing tools to identify exactly which files are recoverable from an install media. Therefore, an embodiment of this invention permits archiving systems to exclude only the redundant data for backup and ensure that all user data is recoverable from the backup memory system. As a result, archiving (backup) software could save many gigabytes of archive storage per system simply by excluding from backup those files that are unchanged from the same files in the installation media, effectively performing an incremental backup relative to the install media. Therefore, an embodiment of the invention improves existing archiving systems by identifying redundant data more precisely. An embodiment of the invention also adapts existing packaging software to make its output more easily usable by archiving systems. These improvements permit users to eliminate large quantities of data from their backups while reducing the risk of omitting otherwise non-recoverable data.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for backup relative to install media, the method comprising:
if a file on the file system is not part of an installed software package, then adding the file to a backup list;
if the file is part of an installed software package, then adding the file to the backup list if the file has changed from a packaged version of the file or if the file is dynamically generated by an installed software package; and
if the file has not changed from a packaged version of the file or is not dynamically generated by an installed software package, then adding the file to an exclude list.

2. The method of claim 1, further comprising:
if the file is part of an installed software package, then adding the installed software package to the package list.

3. The method of claim 1, further comprising:
reading the backup list in order to determine which files are to be copied for backup.

4. The method of claim 1, further comprising:
reading the exclude list in order to determine which files are to be excluded from backup.

5. The method of claim 1, wherein the backup list and exclude list are in a format that is readable by an archiving system.

6. The method of claim 1, wherein the installed software package is installed by use of an installation media.

7. An apparatus for backup relative to install media, the apparatus comprising:
a software packaging tool configured to adding a file to a backup list, if a file on the file system is not part of an installed software package; and
if the file is part of an installed software package, then the software packaging tool is configured to add the file to the backup list if the file has changed from a packaged version of the file or if the file is dynamically generated by an installed software package; and
if the file has not changed from a packaged version of the file or is not dynamically generated by an installed software package, then the software packaging tool is configured to add the file to an exclude list.

8. The apparatus of claim 7, wherein the software packaging tool is configured to add the installed software package to the package list if the file is part of an installed software package.

9. The apparatus of claim 7, further comprising:
an archiving system configured to read the backup list in order to determine which files are to be copied for backup.

10. The apparatus of claim 7, further comprising:
an archiving system configured to read the exclude list in order to determine which files are to be excluded from backup.

11. The apparatus of claim 7, wherein the backup list and exclude list are in a format that is readable by an archiving system.

12. The apparatus of claim 7, wherein the installed software package is installed by use of an installation media.

13. An article of manufacture comprising:
a machine-readable medium having stored thereon instructions to:
add a file to a backup list if the file on the file system is not part of an installed software package;
if the file is part of an installed software package, then add the file to the backup list if the file has changed from a packaged version of the file or if the file is dynamically generated by an installed software package; and
if the file has not changed from a packaged version of the file or is not dynamically generated by an installed software package, then add the file to an exclude list.

14. An apparatus for backup relative to an install media, the apparatus comprising:
means for adding a file to a backup list if a file on the file system is not part of an installed software package;
if the file is part of an installed software package, means for adding the file to the backup list if the file has changed from a packaged version of the file or if the file is dynamically generated by an installed software package; and
if the file has not changed from a packaged version of the file or is not dynamically generated by an installed software package, means for adding the file to an exclude list.
